(19) United States
(12) Patent Application Publication
(10) Pub. No.: US 2010/0204842 A1
(43) Pub. Date: Aug. 12, 2010

(54) Central Monitor and Control Device for High-Concentration Photovoltaic System

(75) Inventors: Chih-Chieh MA, Longtan Shiang (TW); I-Tao LUNG, Zhongli City (TW); Hung-Ju LIN, Bade City (TW)

Correspondence Address: Jackson Intellectual Property Group PLLC, 106 Starvale Lane, Shipman, VA, 22971, US

(73) Assignee: ATOMIC ENERGY COUNCIL-INSTITUTE OF NUCLEAR ENERGY RESEARCH, Taoyuan (TW)

(21) Appl. No.: 12/367,529

(22) Filed: Feb. 8, 2009

(51) Int. Cl. G06F 19/00; G06F 17/30; G06F 15/173; G06F 15/16

(52) U.S. Cl. 700/286; 709/224; 709/203; 707/E17.055

(57) ABSTRACT

A high-concentration photovoltaic system is provided with a central monitor and control system. The central monitor and control system includes a computing unit, a main data base server, a database/web server, three multi-port serial servers, a plurality of switches and a plurality of communication interfaces. With the central monitor and control system, instant monitor, control and inquiry are possible.

### FIELD OF THE INVENTION

The present invention relates to a high-concentration photovoltaic (“HCPV”) system and, more particularly, to a central monitor and control device for an HCPV system with which instant monitor, control and inquiry are possible.

### DESCRIPTION OF THE RELATED ARTS

As technology advances, a lot of energy resources have been exploited. There is a growing concern that we may run out of energy resources. Moreover, massive production of green-house gases entails disastrous global warming. Therefore, a lot of efforts have been made on exploiting solar energy, wind and tides to generate electricity. Access to the solar energy is easy. The generation of the electricity from the solar energy is inexpensive and environmentally friendly.

There are fixed and tracking solar cells. A fixed solar cell is fixed according to a local angle. The fixed solar cell is not always vertical to light beams emitted from the sun. Absorption of the solar energy is low, and the time-related cost of the generation of the electricity from the solar energy is therefore high. The efficiency of the electricity from the solar energy is low.

A tracking solar cell is always vertical to the light beams emitted from the sun. The structure of the tracking solar cell is complicated. Maintenance of the tracking solar cell is difficult and often requires a technician. Therefore, the cost of the maintenance of the tracking solar cell is high.

Moreover, current photovoltaic systems are limited to direct use, without monitoring the optimal respondent angle and direct normal angle in a certain place on the earth and the efficiency of the conversion of direct currents into alternating currents with inverters. The layouts of the current photovoltaic systems are not optimal, and the maintenance is difficult and requires a lot of resources and high costs.

The present invention is therefore intended to obviate or at least alleviate the problems encountered in prior art.

### SUMMARY OF THE INVENTION

It is the primary objective of the present invention to provide an HCPV system with a central monitor and control device with which instant monitor, control and inquiry are possible.

To achieve the foregoing objective, the HCPV central monitor and control system includes a computing unit, a main database server, a database/web server, three multi-port serial servers, a plurality of switches and a plurality of communication interfaces. The computing unit is located in a central control room for running a monitor and control program. The computing unit includes a main monitor and control computer and a backup monitor and control computer. The main database server is a middle-level server located in the central control room, and stores generation-related data. The database/web server I located in the central control room. The database/web server is a middle-level server, and executes a monitor/inquiry web software program as well as stores the generation-related data. The multi-port serial servers are located in a first control room, a second control room and a third control room, respectively. The multi-port serial servers receive two-wired RS485 signals from tracker controllers and inverters and convert the same into Ethernet signals, and are connected to a dedicated network for the HCPV central monitor and control device for providing a communication route between the computing unit and front-end equipment. The switches are located in the central control room. The switches connect the computing unit, the main database server, the database/web server, the dedicated network and an intranet network to one another so that the computing unit accesses to the generation-related data of the front-end equipment and writes the same into the database server and that the database/web server provides data of web monitor and history to an inquiry computer via the intra net network. The communication interfaces are used in a first loop within a first control room, a second loop within a second control room and a third loop within the third control room. Each of the loops includes control lines for controlling trackers and communication lines for collecting data from the inverters.

Other objectives, advantages and features of the present invention will become apparent from the following description referring to the attached drawings

### BRIEF DESCRIPTIONS OF THE DRAWINGS

The present invention will be described via detailed illustration of the preferred embodiment referring to the drawings.

FIG. 1 is a scheme of an HCPV central monitor and control device including a first loop, a second loop and a third loop according to the preferred embodiment of the present invention.

FIG. 2 is an enlarged, more detailed scheme of the third loop shown in FIG. 1.

FIG. 3 is an enlarged, more detailed scheme of the first loop shown in FIG. 1.

FIG. 4 is an enlarged, more detailed scheme of the second loop shown in FIG. 1.

FIG. 5 is a block diagram of a structure of software used in the central monitor and control device shown in FIG. 1.

FIG. 6 is an enlarged, more detailed block diagram of a monitor module shown in FIG. 5.

FIG. 7 is an enlarged, more detailed block diagram of a control module shown in FIG. 5.

### DESCRIPTION OF THE PREFERRED EMBODIMENT

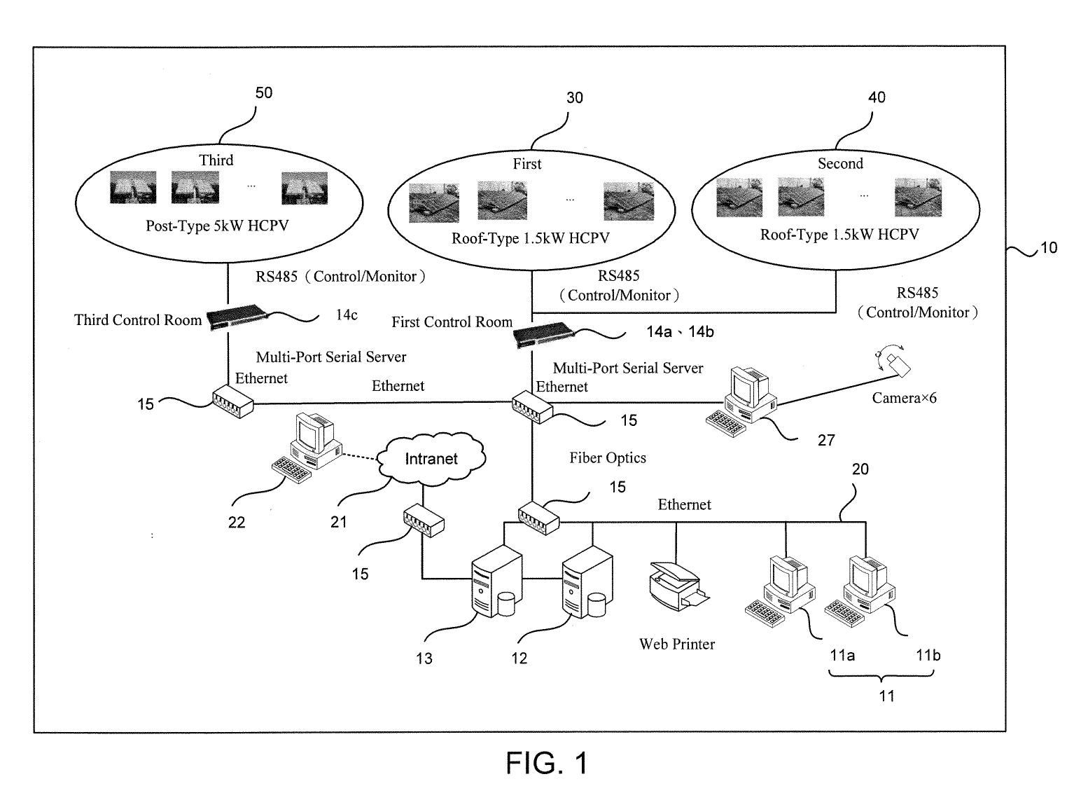

Referring to FIG. 1, an HCPV system is provided with a central monitor and control system according to the preferred embodiment of the present invention. The central monitor and control system includes a computing unit 11, a main database server 12, a database/web server 13, three multi-port serial servers 14a, 14b and 14c, a plurality of switches 15 and a plurality of communication interfaces.

The computing unit 11 consists of a main monitor and control computer 11 a and a backup monitor and control computer 11b. The computing unit 11 is located in a central control room 10. The monitor and control computers 11a and 11b are desktop computers.

The main database server 12 and the database/web server 13 are located in the central control room 10. The main database server 12 stores generation-related data in the HCPV system. The database/web server 13 executes a monitor/inquiry web software program as well as stores the generation-related data of the HCPV system.

The multi-port serial servers 14a, 14b and 14c are located in a first control room, a second control room and a third control room, respectively. The multi-port serial servers 14a, 14b and 14c receive two-wired RS485 signals from tracker controllers and inverters, and convert the same into Ethernet signals. The multi-port servers 14a, 14b and 14c are connected to a dedicated network 20 for the HCPV central monitor and control device, thus providing a communication route between the computing unit 11 and front-end equipment. The multi-port serial servers 14a, 14b and 14c are sixteen-port RS485/Ethernet converting equipment.

The switches 15 are located in the central control room 10. The switches 15 connect the computing unit 11, the main database server 12, the database/web server 13, the dedicated network 20 and an intranet network 21 to one another. Thus, the computing unit 11 accesses to the generation-related data of the front-end equipment and writes the same into the database server 12. Furthermore, the database/web server 13 provides data of web monitor and history to an inquiry computer 22 via the intranet network 21.

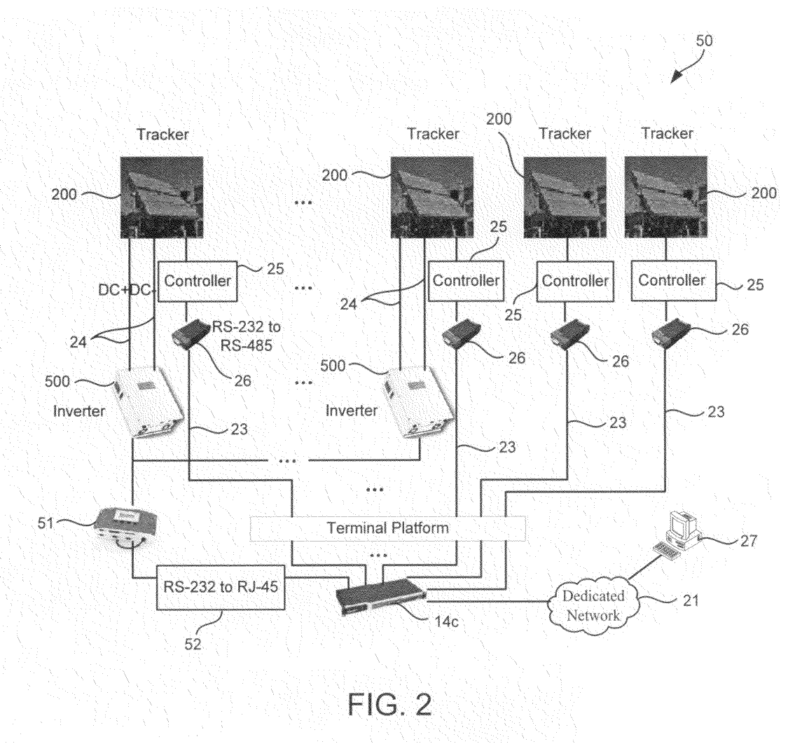

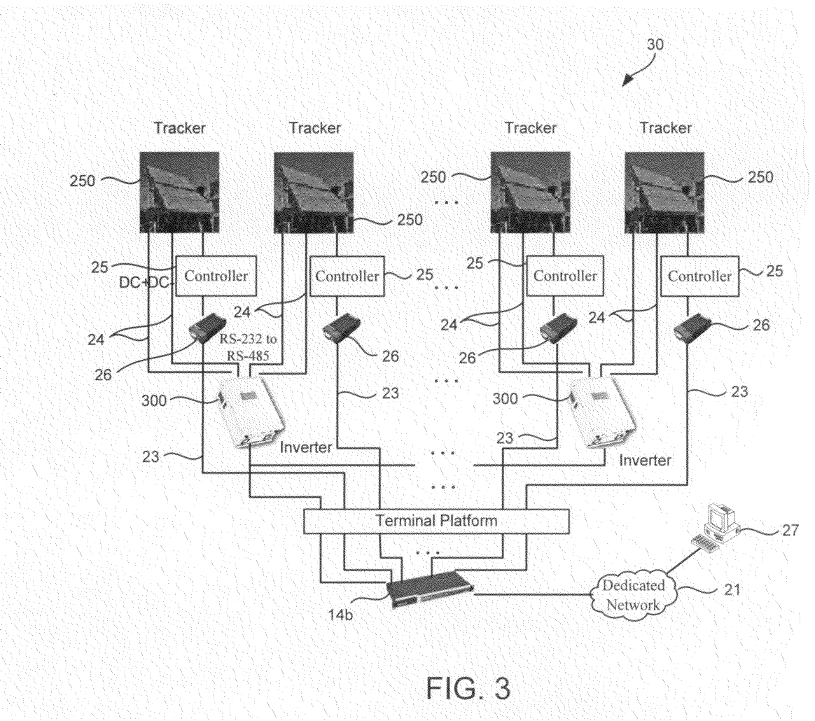

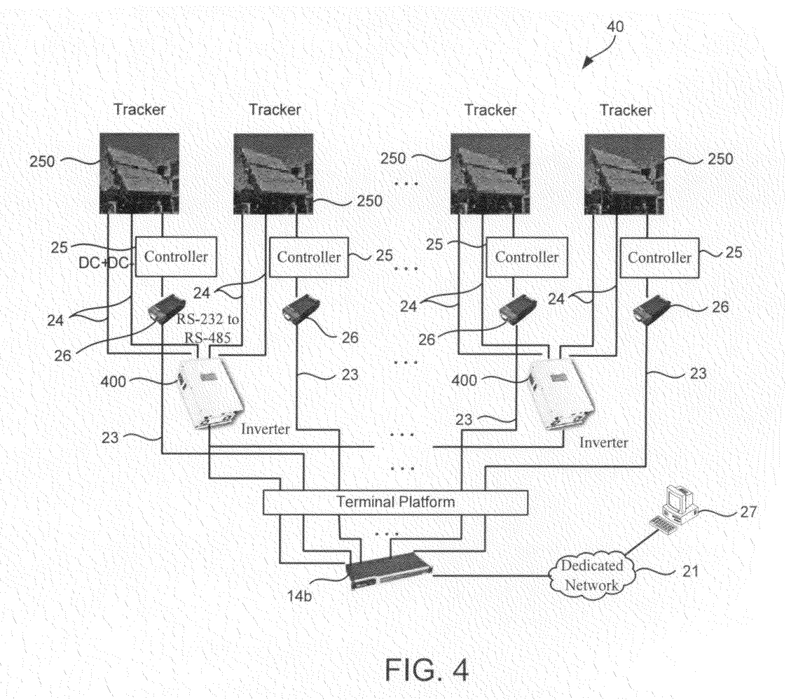

Referring to FIGS. 2 through 4, the communication interfaces are used in a first loop 30, a second loop 40 and a third loop 50 within the first, second and third control rooms. Each loop includes two types of lines. Firstly, there are control lines 23 for controlling trackers. Secondly, there are communication lines 24 for collecting data from the inverter. Preferably, controlled devices of each tracker are connected to a controller 25. Each controller 25 includes an RS232 port 26 for converting signals into RS485 signals through MOXA. The signals are then transferred to the multi-port serial servers 14a, 14b and 14c. Finally, a control computer 27 sends commands to the controllers 25 through the dedicated network 20.

Preferably, the third loop 50 includes a plurality of trackers 200 each connected to an inverter 500. The inverters 500 are connected to one another through RS485 lines and then connected to a port COM1 of a Sunny Boy controller 51. The controller 51 collects data of all of the inverters 500. A port COM2 of a data recorder/controller 51 is converted to an RJ45 connector through an RS232-to-RJ45 inverter 52, and connected to the multi-port serial server 14c. Finally, the control computer reads the data from the data recorder/controller 51 through the dedicated network 20.

The first loop 30 includes inverters 400 connected to one another through RJ45 lines and then connected to the multi-port serial server 14a. Finally, the control computer 27 reads the data from the inverters 300 through the dedicated network 20.

The second loop 40 includes inverters 400 connected to one another through RJ45 lines and then connected to the multi-port serial server 14b. Finally, the control computer 27 reads the data from the inverters 400 through the dedicated network 20. Each inverter 400 is connected to two trackers 250.

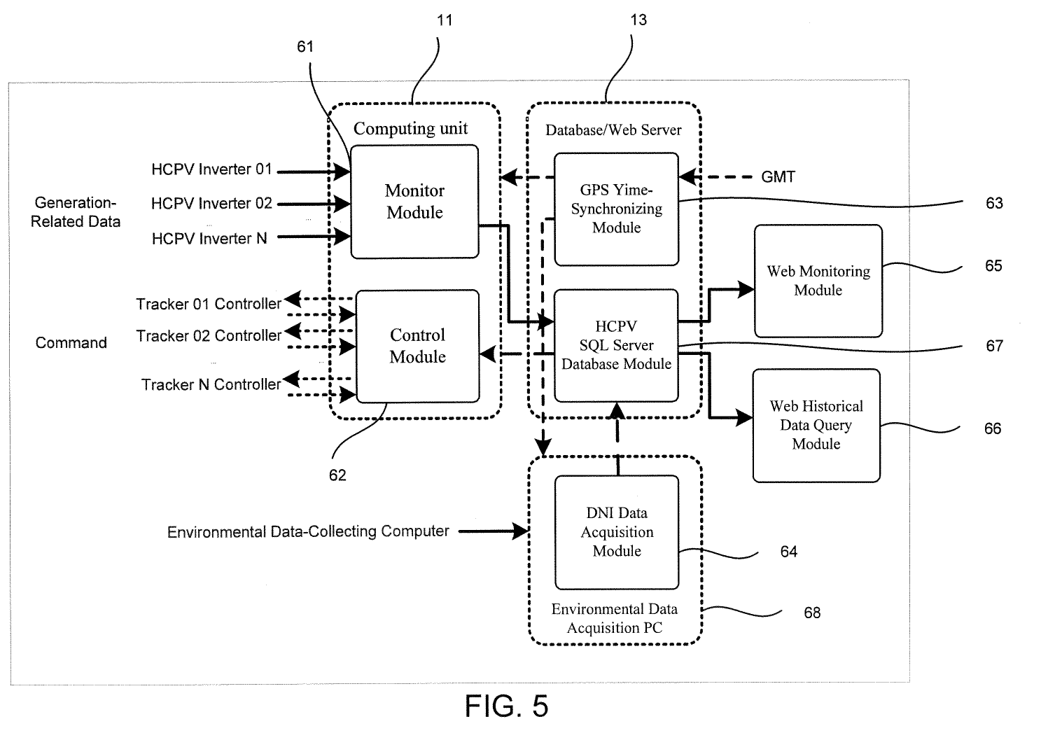

Referring to FIGS. 5 through 7, executed in the HCPV central monitor and control device is software including a monitor module 61, a control module 62, a global positioning system (“GPS”) time-synchronizing module 63, a DNI data-acquisition module 64, a web-monitor module 65, a web historical data-inquiry module 66 and a SQL server database module 67.

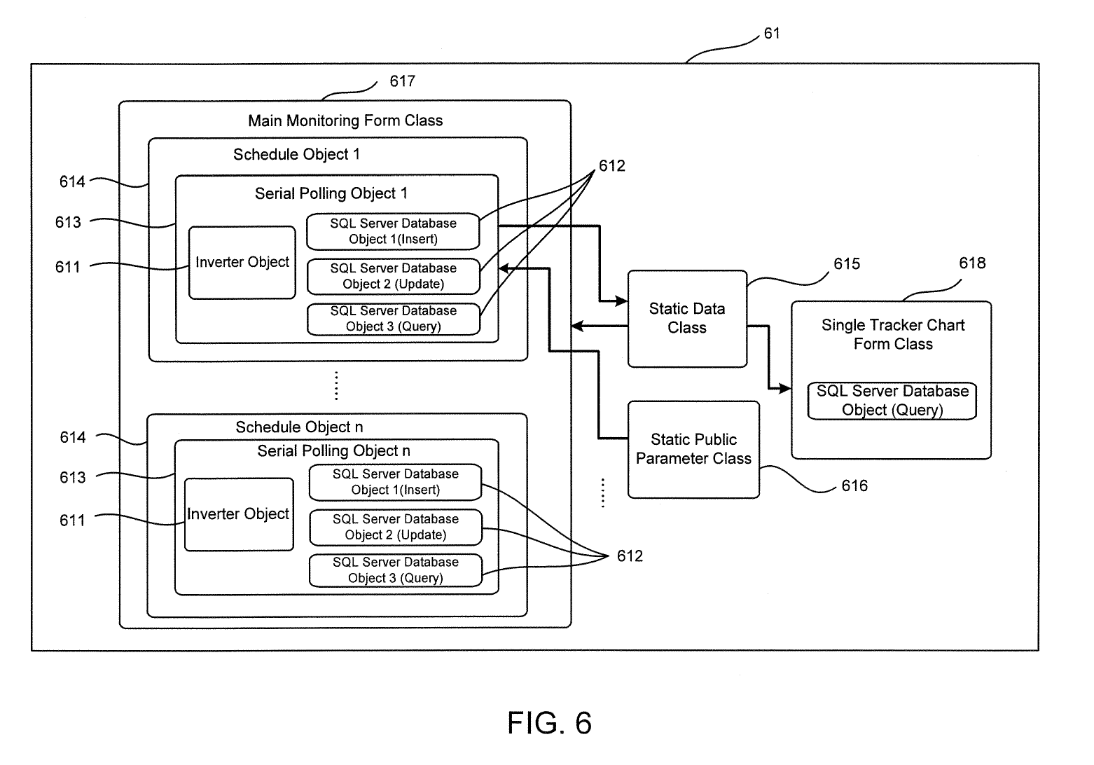

As best shown in FIG. 6, the monitor 61 is connected to the invertors in a star-shaped manner mixed with an annular manner. The monitor module 61 acquires the generation-related data from the inverters in a multi-threading polling manner, and shows the same on the computing unit 11 within the central control room. The monitor module 61 interprets the generation-related data before it stores the same in the SQL server databases of the database/web servers 13 according to a fixed form, and shows the current status, the generation-related data and trend diagrams of the trackers on the computing unit 11.

The monitor module 61 includes an inverter class 611, an SQL server database class 612, a serial polling class 613, a schedule class 614, a static data class 615, a static public parameter class 616, a main monitor form class 617 and a single tracker chart form class 618. The inverter class 611 defines a brand and a communication specification of an inverter. The SQL server database class 612 defines methods for connection, disconnection, asynchronous inquiry and writing. The serial polling class 613 defines functions of and methods for a serial port transmission mechanism and message interpretation. The schedule class 614 defines a monitor schedule in a multi-threading manner. The static data class 615 defines the generation-related data. The static public parameter class 616 defines public parameters of the system. The main monitor form class 617 monitors a main screen of a monitor program. The single tracker chart form class 618 shows data and a trend of a single tracker. Items derived from the definition and combination of the foregoing classes with one another build all of the functions of the monitor program. The derived items are combined with one another to form a software structure of the monitor module 61.

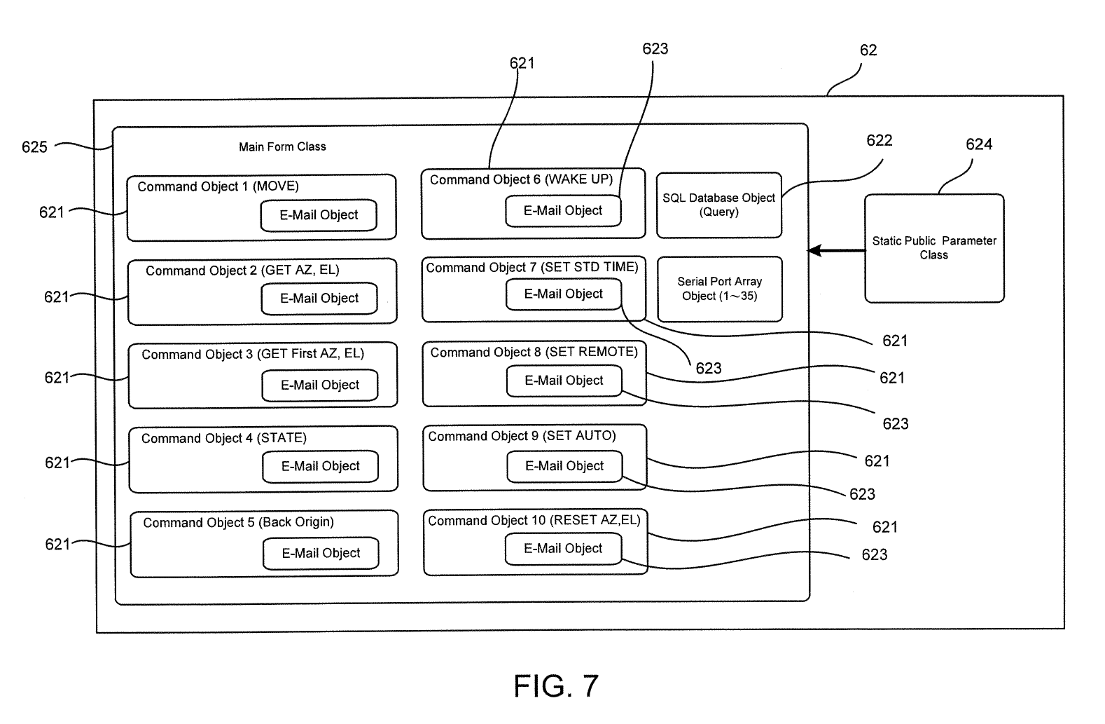

Referring to FIG. 7, the control module 62 communicates with the trackers in a star-shaped manner through the dedicated network interface. In the computing unit 11 within the central control room, the control module 62 gives commands to the trackers in a multi-threading manner to automatically synchronizing time, return to an original point, get ready, automatically/remotely switch and read the DNI data. If necessary, an operator can manually give commands to one or more of the trackers.

The control module includes a command class 621, an SQL server database class 622, an email class 623, a public static parameter class 624 and a main form class 625. The command class 621 defines a form for transmitting commands and receiving messages between the tracker controllers and the control program. The SQL server database class 622 defines methods for connection, disconnection and asynchronous inquiry. The email class 623 defines email for a responsible person in case where commands cannot effectively be transmitted. The public static parameter class 624 defines public parameters. The main form class 625 controls a main screen of the control program. Items derived from the definition and combination of the foregoing classes with one another build all of the functions of the control program. The derived items are combined with one another to form a software structure of the control module 62.

The GPS time-synchronizing module 63 interprets satellite data received with a GPS module within the third control room, converts the GMT to local time, sets time for the database/web server 13. Moreover, the GPS time-synchronizing module 63 runs time-synchronizing software to set time for the computing unit 11 and an environmental data-collecting computer 68 once half an hour.

Once every minute, the DNI data-acquisition module 64 receives the DNI data from the environmental data-collecting computer 68, and writes the same into the SQL server database module 67. Thus, the monitor program calculates the efficiency of the generation, and the control program judges between the automatic and remote modes.

The web-monitoring module 65 acquires the generation-related data from the SQL server database module 67, and shows the same on a browser webpage.

The web historical data-inquiry module 66 provides an interface for statics, analysis and inquiry of historical data, sets conditions for various inquiries, and provides results in charts, tables or words.

The SQL server database module 67 is an information core of the HCPV central monitor and control apparatus. The SQL server database module 67 receives and stores the generation-related data and the DNI data as sources of data and standards for judging of the automatic control for the web-monitoring module 65 and the web historical data-inquiry module 66.

As discussed above, the central monitor and control apparatus acquires the generation-related data through the RS485 and the Ethernet, instantly shows the same on the computing unit 11 within the central control room and stores the same in the database/web server 13. Thus, the generation-related data and the web historical data can be reviewed through the browser. Commands can be given to the controllers 25. Conclusively, the central monitor and control device provides instant monitor, control and inquiry.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An HCPV central monitor and control system comprising:
a computing unit located in a central control room for running a monitor and control program, wherein the computing unit comprises a main monitor and control computer and a backup monitor and control computer;
a main database server located in the central control room, wherein the main database server is a middle-level server, and stores generation-related data;
a database/web server located in the central control room, wherein the database/web server is a middle-level server, and executes a monitor/inquiry web software program as well as stores the generation-related data;
three multi-port serial servers located in a first control room, a second control room and a third control room, respectively, wherein the multi-port serial servers receive two-wired RS485 signals from tracker controllers and inverters, and convert the same into Ethernet signals, and are connected to a dedicated network for the HCPV central monitor and control device for providing a communication route between the computing unit and front-end equipment;
a plurality of switches located in the central control room, wherein the switches connect the computing unit, the main database server, the database/web server, the dedicated network and an intranet network to one another so that the computing unit accesses to the generation-related data of the front-end equipment and writes the same into the database server and that the database/web server provides data of web monitor and history to an inquiry computer via the intranet network; and
a plurality of communication interfaces used in a first loop within a first control room, a second loop within a second control room and a third loop within the third control room, wherein each of the loops includes control lines for controlling trackers and communication lines for collecting data from the inverters.

2. The central monitor and control device according to claim 1, wherein the monitor and control computers are desk-top computers.

3. The central monitor and control device according to claim 1, wherein the multi-port serial servers are sixteen-port RS485/Ethernet converting equipment.

4. The central monitor and control device according to claim 1, wherein controlled devices of each tracker are connected to a controller, and each controller includes an RS232 port for converting signals into RS485 signals through MOXA, and the signals are then transferred to the multi-port serial servers so that a control computer finally sends commands to the controllers through the dedicated network.

5. The central monitor and control device according to claim 1, wherein the third loop comprises a plurality of trackers each connected to an inverter, the inverters are connected to one another through RS485 lines and then connected to a port COM1 of a Sunny Boy controller, the controller collects data of all of the inverters, a port COM2 of a data recorder/controller is converted to an RJ45 connector through an RS232-to-RJ45 inverter and connected to the multi-port serial server so that the control computer finally reads the data from the data recorder/controller through the dedicated network.

6. The central monitor and control device according to claim 1, wherein the first loop comprises inverters connected to one another through RJ45 lines and then connected to the multi-port serial server so that the control computer finally reads the data from the inverters through the dedicated network.

7. The central monitor and control device according to claim 1, wherein the second loop comprises inverters connected to one another through RJ45 lines and then connected to the multi-port serial server so that the control computer finally reads the data from the inverters through the dedicated network.

8. The central monitor and control device according to claim 6, wherein each of the inverters is connected to two related ones of the trackers.

9. An HCPV central monitor and control device executing software comprising:
a monitor module connected to invertors in a star-shaped manner mixed with an annular manner, wherein the monitor module acquires generation-related data from the inverters in a multi-threading polling manner, shows the same on a computing unit within a central control room, interprets the generation-related data before it stores the same in SQL server databases of database/web servers according to a fixed form, and shows the current status, the generation-related data and trend diagrams of trackers on the computing unit;
a control module in communication with the trackers in a star-shaped manner through the dedicated network interface, in the computing unit within the central control room, the control module gives commands to the trackers in a multi-threading manner to automatically synchronizing time, return to an original point, get ready, automatically/remotely switch and read DNI data;
a global positioning system time-synchronizing module for interpreting satellite data received with a global positioning system module within a control room, converting the Greenwich Mean Time to local time, setting time for the database/web server, and running time-synchronizing software to set time for the computing unit and an environmental data-collecting computer once half an hour;
a DNI data-acquisition module for receiving the DNI data from the environmental data-collecting computer and writing the same into the SQL server database module once every minute so that a monitor program calculates the efficiency of the generation and that the control program judges between the automatic and remote modes;
a web-monitor module for acquiring the generation-related data from the SQL server database module and showing the same on a browser webpage;
a web historical data-inquiry module for providing an interface for statics, analysis and inquiry of historical data, setting conditions for various inquiries, and providing results in charts, tables or words; and
a SQL server database module being an information core of the HCPV central monitor and control apparatus for receiving and storing the generation-related data and the DNI data as sources of data and standards for judging of the automatic control for the web-monitoring module and the web historical data-inquiry module.

10. The central monitor and control device according to claim 9, wherein the monitor module comprises:
an inverter class for defining a brand and a communication specification of each inverter;
an SQL server database class for defining methods for connection, disconnection, asynchronous inquiry and writing;
a serial polling class for defining functions of and methods for a serial port transmission mechanism and message interpretation;
a schedule class for defining a monitor schedule in a multi-threading manner;
a static data class for defining the generation-related data;
a static public parameter class for defining public parameters of the system;
a main monitor form class for monitoring a main screen of a monitor program; and
a single tracker chart form class for showing data and a trend of a single tracker.

11. The central monitor and control device according to claim 9, wherein the control module comprises:
a command class for defining a form for transmitting commands and receiving messages between the tracker controllers and the control program;
an SQL server database class for defining methods for connection, disconnection and asynchronous inquiry;
an email class for defining email for a responsible person in case where commands cannot effectively be transmitted;
a public static parameter class for defining public parameters; and
a main form class for controlling a main screen of the control program.

12. The central monitor and control device according to claim 11, wherein commands can be given to at least one of the trackers manually if necessary.
